(19) United States
(12) Patent Application Publication
(10) Pub. No.: US 2016/0342352 A1
(43) Pub. Date: Nov. 24, 2016

(54) ENCODING DATA IN A MEMORY ARRAY

(71) Applicant: HEWLETT PACKARD ENTERPRISE DEVELOPMENT LP, Houston, TX (US)

(72) Inventors: Gregg B LESARTRE, Fort Collins, CO (US); Naveen MURALIMANOHAR, Santa Clara, CA (US); Yoocharn JEON, Palo Alto, CA (US)

(21) Appl. No.: 15/114,939

(22) PCT Filed: Jan. 31, 2014
(86) PCT No.: PCT/US2014/014124

§ 371 Date: Jul. 28, 2016

(51) Int. Cl. G06F 3/06

(52) U.S. Cl. CPC G06F 3/0619; G06F 3/0625; G06F 3/065; G06F 3/0689

(57) ABSTRACT

A method for encoding data in a memory array is described. The method includes receiving data to be stored in the memory array. The method also includes encoding the data, to generate a number of encoded data versions. The method also includes selecting, based on a number of optimization heuristics, which of a number of data versions to store in the memory array. The number of data versions include the number of encoded data versions and the data. The method also includes indicating, in metadata associated with the data, the selected data version. The method also includes writing the selected data version, the metadata, or combination thereof, to the memory array.

### BACKGROUND

Memory devices are used to store data. Memory devices may have different characteristics based on the value written to the memory device. For example, memory devices may have different electrical profiles based on the value written to the memory device. Different values written to memory may also give memory devices different latencies. Memory devices may develop errors based on the number of times the memory is written.

### BRIEF DESCRIPTION OF THE DRAWINGS

The accompanying drawings illustrate various examples of the principles described herein and are a part of the specification. The examples do not limit the scope of the claims.

FIG. 1 is a diagram of a system for encoding data in a memory array according to one example of the principles described herein.

FIG. 2 is a flowchart of a method for encoding data in a memory array according to one example of the principles described herein.

FIG. 3 is a flowchart of another method for encoding data in a memory array according to one example of the principles described herein.

FIG. 4 is a diagram of a system for encoding data in a memory array according to one example of the principles described herein.

FIG. 5 is a diagram of data as it may be written according to one of the example principles herein.

FIG. 6 is a diagram of data as it may be written according to one of the example principles herein.

Throughout the drawings, identical reference numbers designate similar, but not necessarily identical, elements.

### DETAILED DESCRIPTION

Memory arrays may provide access to system memory and storage. Some memory arrays such as memristor arrays may provide high speed access to memory. However, while such memory arrays may be beneficial, their use may be impeded by certain complications. For example, some memory arrays, such as memristor arrays, may be organized into cross point arrays that may consume power whenever a bit is read or written. The amount of power consumed during operation may vary based on a number of factors, including the underlying technology and the other values stored in the memory device. Data patterns written to the memory array may alter the power consumption of a system using that device. Some memory arrays may vary in useful lifetime according to the power consumption, state variance within a memory array, or the number of state transitions experienced by a memory array. A reduction in the state variance or state transitions may increase the utility of the memory array.

Accordingly, the systems and methods disclosed herein allow data to be encoded to reduce average power consumption, extend device lifetime, and provide more consistent memory operation by providing for alternative formats to store data within a memory array. For example, data may be written to a memory array in units, such as cache lines. Each storage unit may contain metadata, which is controlled by the system, to provide data protection and additional information. By encoding the data to be written, and storing information regarding the encoding in the additional data, the behavior of a memory array may be altered.

A memory array, such as memristor array, may use more power if various bits are surrounded by bits in a low resistance, or zero state. The data may be encoded to reduce power usage by encoding the data to increase the number of high resistance bits. An example of an encoding would be to invert the value of bits in the data. By encoding data in this matter, data with a low resistance pattern could be modified to have a high resistance pattern, which may reduce power consumption.

In some examples, metadata may be stored in association with the encoded data. The metadata may include information such as an error correction code (ECC), information indicating how the data has been encoded, or similar information. When the data is retrieved, the additional data may be read to provide how the data was encoded, allowing for the data to be decoded and restored to its original state.

The present disclosure describes a method for encoding data in a memory array. The method may include receiving data to be stored in the memory array. The method may also include encoding the data to generate a number of encoded data versions. The method may also include selecting, based on a number of optimization heuristics, which of a number of data versions to store in the memory array. The data versions may include the number of encoded data versions and the data. The method may include indicating, in metadata associated with the data, the selected data version. The method may include writing the selected data version, the metadata, or combination thereof, to the memory array.

The present disclosure describes a system for encoding data in a memory array. The system may include a processor and memory communicatively coupled to the processor. The system may also include a memory manager. The memory manager may include an encode module to encode data to generate a number of encoded data versions. The memory manager may also include a select module to compare the number of encoded data versions and the data, and to select an encoded data version, the data or combinations thereof based on a number of optimization heuristics. The memory manager may include a metadata module to generate a number of metadata bits. The metadata bits may indicate a data version selected. The system may include an association module to associate the number of metadata bits with the selected data version. The system may include a write module to write the selected data version, metadata, or combination thereof, to the memory array.

The present disclosure describes a computer program product for encoding data in a memory array. The computer program product may include a computer readable storage medium that includes computer usable program code embodied therewith. The computer usable program code may include computer usable program code to, when executed by a processor, receive data to be stored in a memory array. The computer usable program code may also include computer usable program code to, when executed by a processor, encode the data to generate a number of encoded data versions. The computer usable program code may also include computer usable program code to, when executed by a processor, select one of the data and an encoded data version to store in the memory array. The computer usable program code may also include computer usable program code to, when executed by a processor, indicate, via metadata associated with the data, the selection. The computer usable program code may also include computer usable program code to, when executed by a processor, write the selected data and the metadata to the memory array.

Benefits beyond the amount of power consumed during operation may be realized. For example, some memory may develop errors causing the memory array to return a constant value for a particular memory address. The contents of the address may become “stuck at” a value. By storing the data such that the encoding matches the content of the particular memory address experiencing an error, the memory array may increase in robustness.

Still further, an encoding may also be selected to reduce state change, or the number of times bits in memory change from one to zero or zero to one, with the previous value stored to a memory location. A reduction in state change may prolong the life of a memory array when the lifetime of the underlying technology varies based on such state transitions.

As used in the present specification and in the appended claims, a “memristor memory,” “memristor,” or similar terminology may refer to memory that is a passive circuit element that may maintain a relationship between the time integrals of current and voltage across a two terminal element. Accordingly, a “memristor array” may refer to multiple memristor elements.

Still further, as used in the present specification and in the appended claims, the term “encoded data version” may refer to a number of encodings of original data. By comparison, the term “data version” may refer to the number of encoded data versions as well as the original data.

Even further, as used in the present specification and in the appended claims, the term “a number of” or similar language may include any positive number including one to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

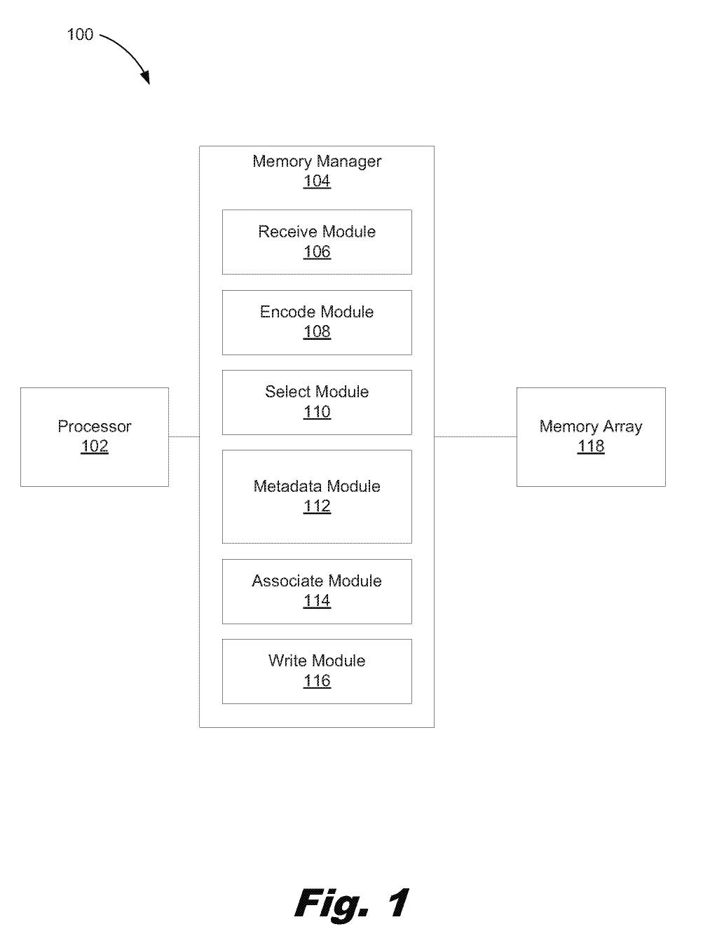

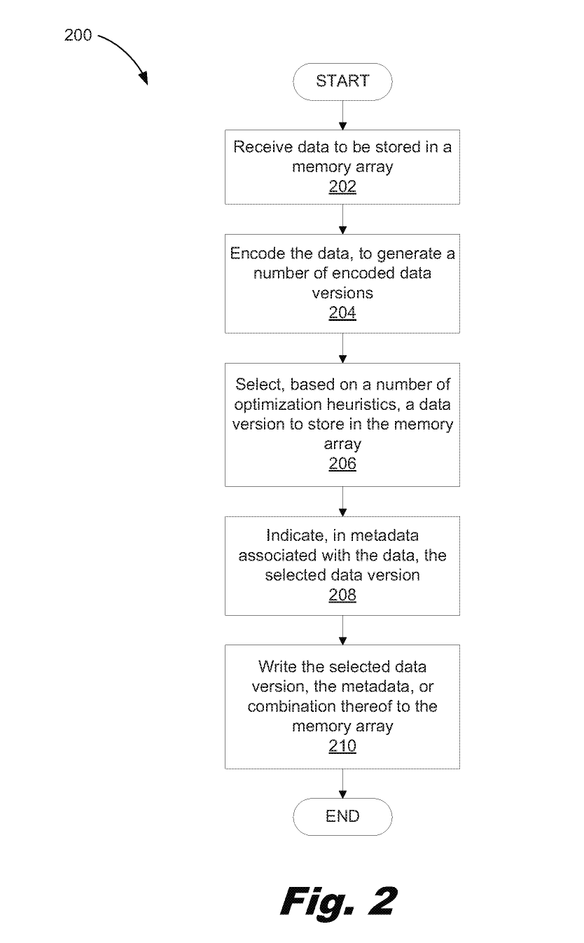

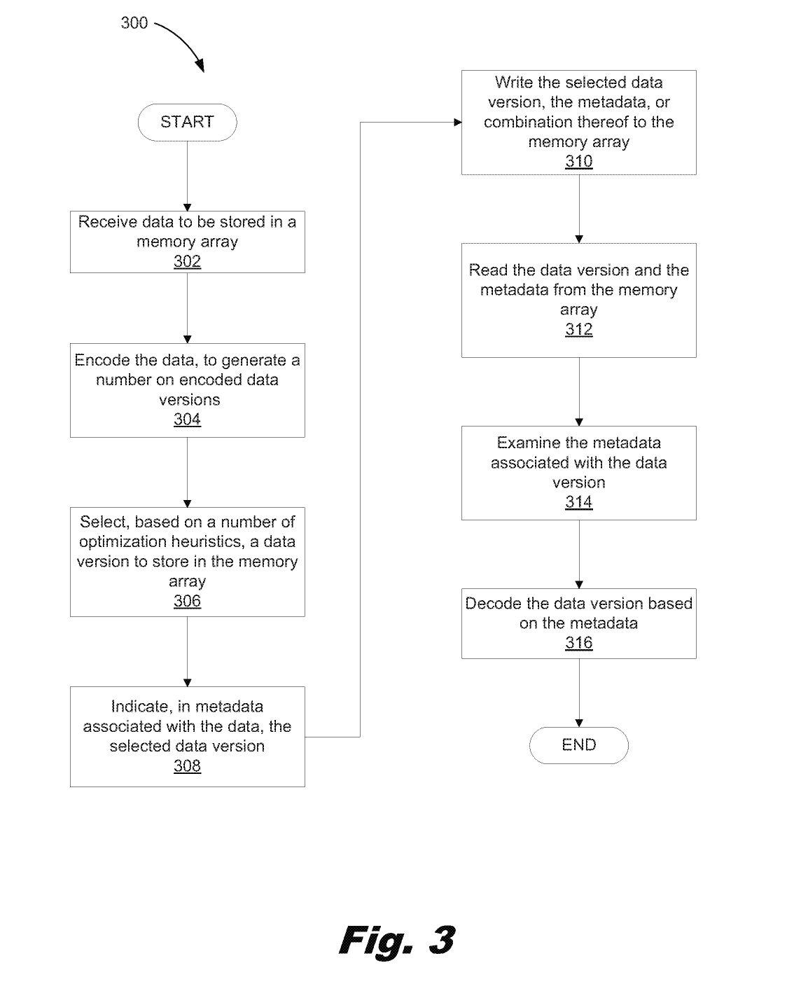

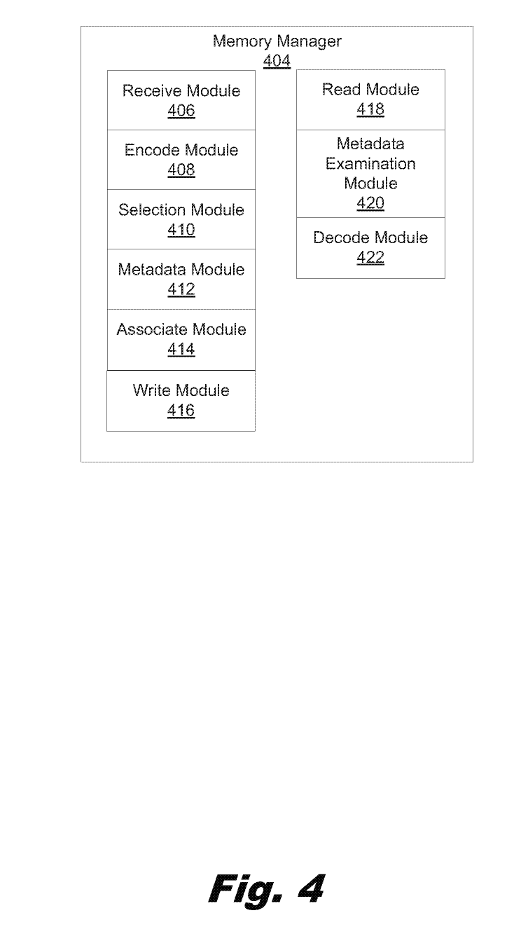

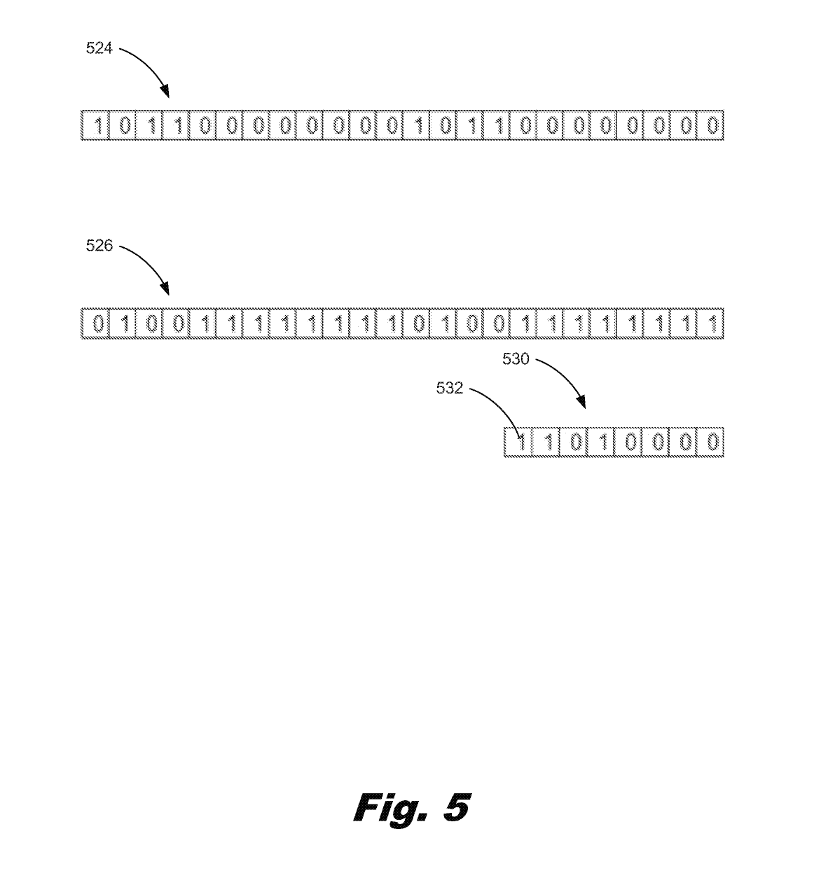

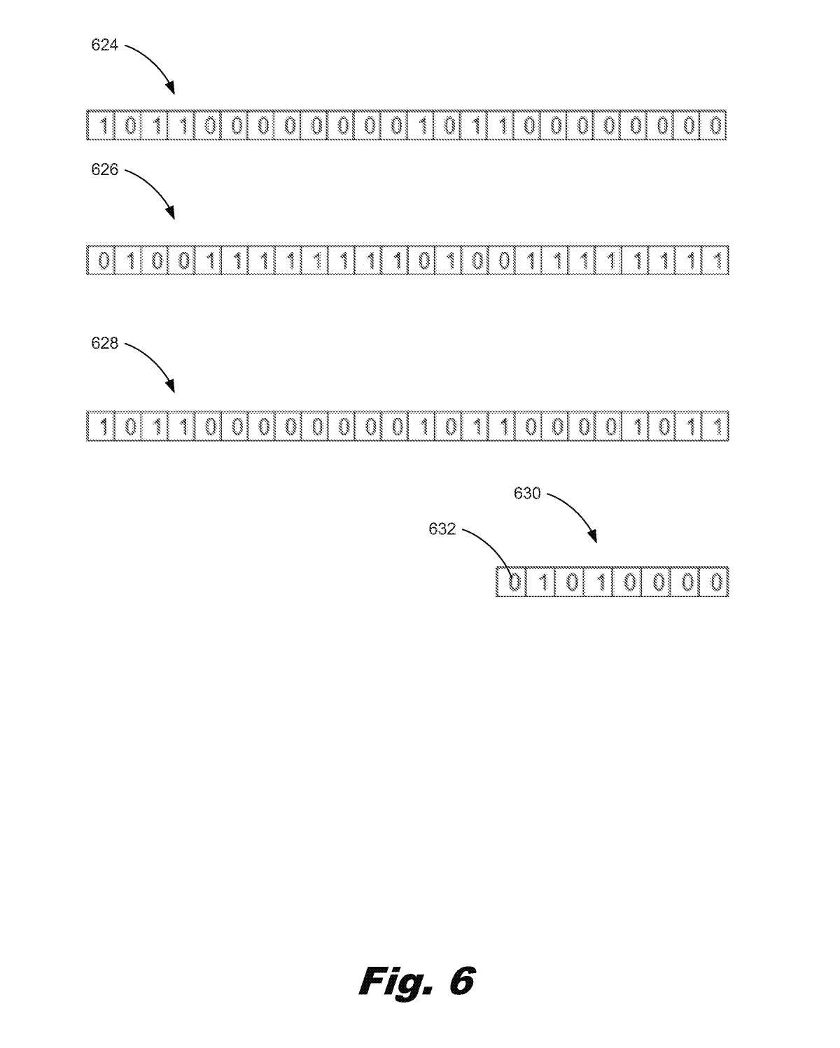

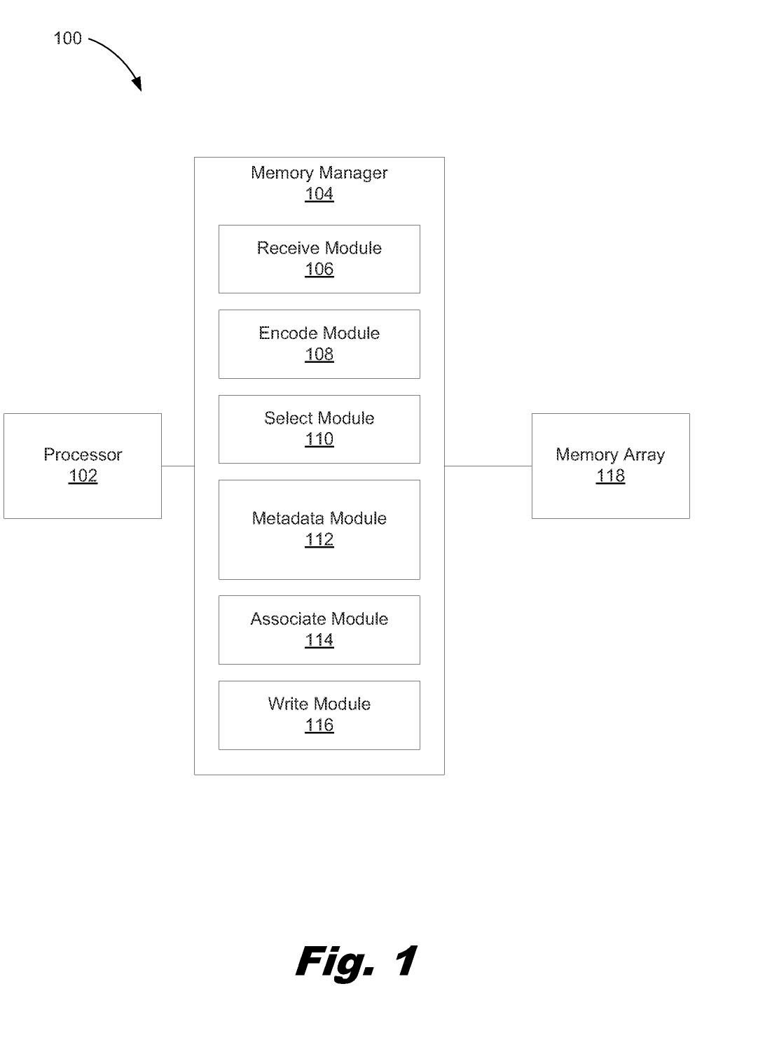

Referring now to the figures, FIG. 1 is a diagram of an example of a memory system (100) according to one example of the principles described herein. As will be described, the memory system (100) may include a processor (102), a memory manager (104), and a memory array (118).

The processor (102) may be a single processor, or may be multiple processors. The processor (102) may reside on a single computer chip, or may reside on multiple computer chips. The processor (102) may execute computer usable code in a general purpose computer system, may execute computer usable code as part of an embedded system, or may execute computer usable code in a similar computing environment.

The processor (102) may include the hardware architecture to retrieve executable code from memory and execute the executable code. The executable code may represent instructions that, when executed by the processor (102), cause the processor (102) to implement at least the functionality of encoding data in a memory array (118), according to the methods of the present specification described herein. In the course of executing code, the processor (102) may receive input from and provide output to a number of the remaining hardware units.

The memory manager (104) may execute on the processor (102) or may execute in a separate computing environment. Generally, the memory manager (104) may comprise a computer readable medium, a computer readable storage medium, or a non-transitory computer readable medium, among others. In the context of this document, a computer readable storage medium may be any tangible medium that can contain, or store a program for use by or in connection with an instruction execution system, apparatus, or device. In another example, a computer readable storage medium may be any non-transitory medium that can contain, or store a program for use by or in connection with an instruction execution system, apparatus, or device.

The memory manager (104) may further comprise a number of modules used in the encoding of data within a memory array (118). The various modules within the memory system (100) may be executed separately. In this example, the various modules may be stored as separate computer program products. In another example, the various modules within the memory system (100) may be combined within a number of computer program products; each computer program product comprising a number of the modules. The memory manager (104) may contain a receive module (106), an encode module (108), a select module (110), a metadata module (112), an associate module (114), and a write module (116). The memory manager (104) may perform additional functions than those described herein. The receive module (106) may receive data to be written to the memory array (118). The source of this data may include computer usable code executing on the processor (102), or may originate from another device such as a network card or an input device. The source of the data may communicate with the receive module (104) that the data should be stored in the memory array (118).

The encode module (108) may process the data into a number of encoded data versions. The encoding may maintain the size of the data, may reduce the size of the data, or may increase the size of the data. The encode module (108) may produce a number of versions of encoded data. The encode module (108) may include information regarding the memory array (118) that enables the encoding to optimize the data output based on the characteristics of the memory array (118). An example of an encoding is to create a bitwise inversion of the binary representation of the data, causing every zero to become a one and every one to become a zero. For example, a data pattern of 1001 would become 0110. By encoding the data prior to a write operation, the encode module (108) may provide alternative representations of the data that allow the stored data to consume less power, reduce wear on memory components, or compensate for errors in the memory array (118).

The select module (110) may compare encoded versions of the data produced by the encoding module (108) and the original data and may select a data version to be stored in the memory array (118). As used in the present disclosure a data version may include the encoded versions of the data and the original data. A version of data may be selected based on projected electrical usage based on the data, an irregularity in the memory array (118), the current state of the memory array (118), or other factors relating the memory array (118). The select module (110) may compare multiple versions of the encoded data and the original data using optimization heuristics to determine a data version to be written to the memory (118).

As an example, the select module (110) may favor the writing of positive bits (ones) to the memory array (118). For example, an original data set of 64 bits that contains 8 positive bits may be compared against an encoded version of the data that is an inversion of the data. The encoded data version may also have 64 bits, but may have 56 positive bits. When the optimization heuristic favors positive bits being written to the memory array (118), the encoded data may be selected for storage in place of the original data. Encoding the data based on the projected power consumption allows the select module (110) to reduce the overall power consumption by the memory array (118).

Another example may be when a specific bit in the memory array (118) may have malfunctioned. The memory manager (104) may read information related to bit errors in the memory array (118). The profile of the data may be adjusted to ensure any bit with an error remains in a consistent state. In other words, an error may be detected when a bit does not maintain what has been written to that bit. For instance, if a bit has the value one written to it, and then is read and returns the value of that bit is zero, the bit has an error. An encoding may then be selected that would write zero to the bit. Selecting data so that a bit with an error does not change state may allow the memory manager (104) to extend the life of a memory array (118).

When the memory manager (104) determines that a memory location within a memory array (118) may no longer function as expected, the memory manager (104) may write an embedded pointer indicating a remapped location for the data that may have been stored at that location.

Another example may be to compare the data versions against the present value of a location in a memory array (118) to be written. A determination may then be made of how many binary digits would change state for each encoding. The encoding that changes the least number of bits may be selected for writing. Selecting data to write to minimize state change in the memory array (118) may extend the life of the memory array (118).

Through an examination of the data versions including the encoded data and the original data, the select module (110) may select the data version that optimizes the storage of the data in the memory array (118) based on characteristics such as power consumption, reduction in state changes of the memory array (118), compensation for errors in a memory array (118), or other memory array (118) characteristics.

Once a version of data is selected to be written to the memory array (118), the metadata module (112) may record in metadata which data version was selected. The metadata may be used to store which data version was used, or may be included as part of metadata associated with the memory array (118) that stores additional data. An example of metadata that stores additional data is ECC data. Sufficient data may be included so as to allow for the data to be decoded and returned to its original state.

The associate module (114) may associate the metadata with the data version to be written. The metadata may be written to the same device as the encoded data, or may be written to a different device. The association module (114) may coordinate such that the data to be written can locate the correct metadata, and the metadata can be associated with the encoded data that is written to the memory array (118).

The write module (116) may ensure that the selected data version and the metadata are written to the memory (118). The write module (116) may invoke a system write routine that causes the data to be stored in the memory array (118).

The memory array (118) may be of a variety of types associated with computing environments, whether now existing or hereafter discovered. The memory array (118) may be a volatile memory type, such as double data rate (DDR) ram. The memory array (118) may also be a stable memory type, such as memristor, cross bar or synchronous dynamic random access memory (SDRAM). A stable memory type may also include a storage device such as a hard disk, a tape device or any similar device.

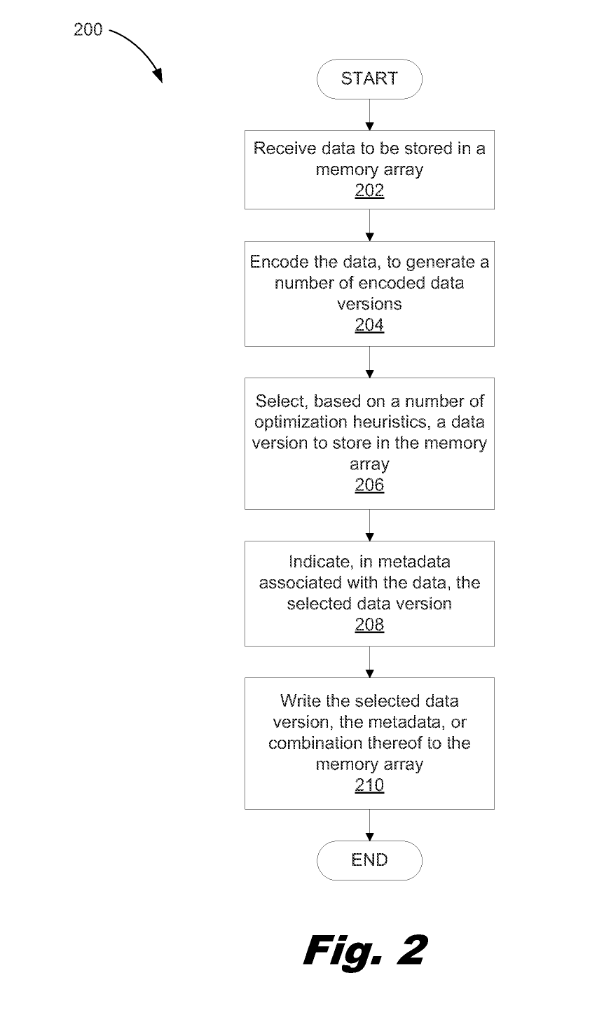

FIG. 2 is a flowchart of a method (200) for encoding data in a memory array (FIG. 1, 118) according to one example of the principles described herein. The method (200) may allow for writing data, which may be encoded, to a memory array (FIG. 1, 118).

The method (200) may include receiving (block 202) data to be stored in a memory array (FIG. 1, 118). For example, data may be received from other sources that may be written to the memory array (FIG. 1, 118). The method (200) may include encoding (block 204) the data to generate a number of encoded data versions. A routine is executed, encoding the data. Encoding may include performing a bitwise inversion of the data, leaving the data in its original format, or may involve more complex encoding that provides different distributions of output data. The method may produce a number of encoded versions of the original data.

The method (200) may include selecting (block 206), based on optimization heuristics comparing the encoded data versions and the original data, a data version to store in the memory array (FIG. 1, 118). Selecting (block 206) a version of the data may include examining the characteristics of the encoded data and the original data. Selecting (block 206) a version of the data to store may also include considering optimization heuristics regarding the storage characteristics relating to data storage of the memory array (FIG. 1, 118), which may include projected power consumption based on the data stored, projected impact to the memory array (FIG. 1 118), projected latency to write the data to the memory array (FIG. 1, 118), or other characteristics of the memory array (FIG. 1, 118) or data.

The selecting (block 206), based on heuristics may change over the life of the memory array (FIG. 1, 118). A memory array (FIG. 1, 118) that does not have errors may be optimized to reduce power consumption. As the memory array is used, the selecting (block 206) may optimize to reduce the projected impact on the memory array (FIG. 1, 118). When errors develop in the memory array, the selecting (block 206) may write encoded data versions that may extend the life of the memory array (FIG. 1, 118).

The selection (block 206) may benefit the usefulness of a memory array (FIG. 1, 118) by reducing power consumption, reducing impact in the memory array (FIG. 1, 118), extending the life of the memory array (FIG. 1, 118), or may combine these effects with other similar beneficial effects.

Indicating (block 208), in metadata associated with the selected data version, the encoding used may include storing information that indicates how the data was encoded, and may include information to decode the data. The information may be an indication that the data is encoded, or may include additional information to decode the data. Such information may allow for the decoding of the data by other modules.

Writing (block 210) the selected data version and the metadata to the memory array (FIG. 1, 118) may include storing the selected data version and the associated metadata. Storing the selected data version, metadata, or combination thereof allows for future retrieval of the information, either by the system that wrote the data or by a different system. Writing (block 210) the selected data version, the metadata, or combination thereof may depend on system write routines to store the data, the metadata, or combination thereof in memory (FIG. 1, 118).

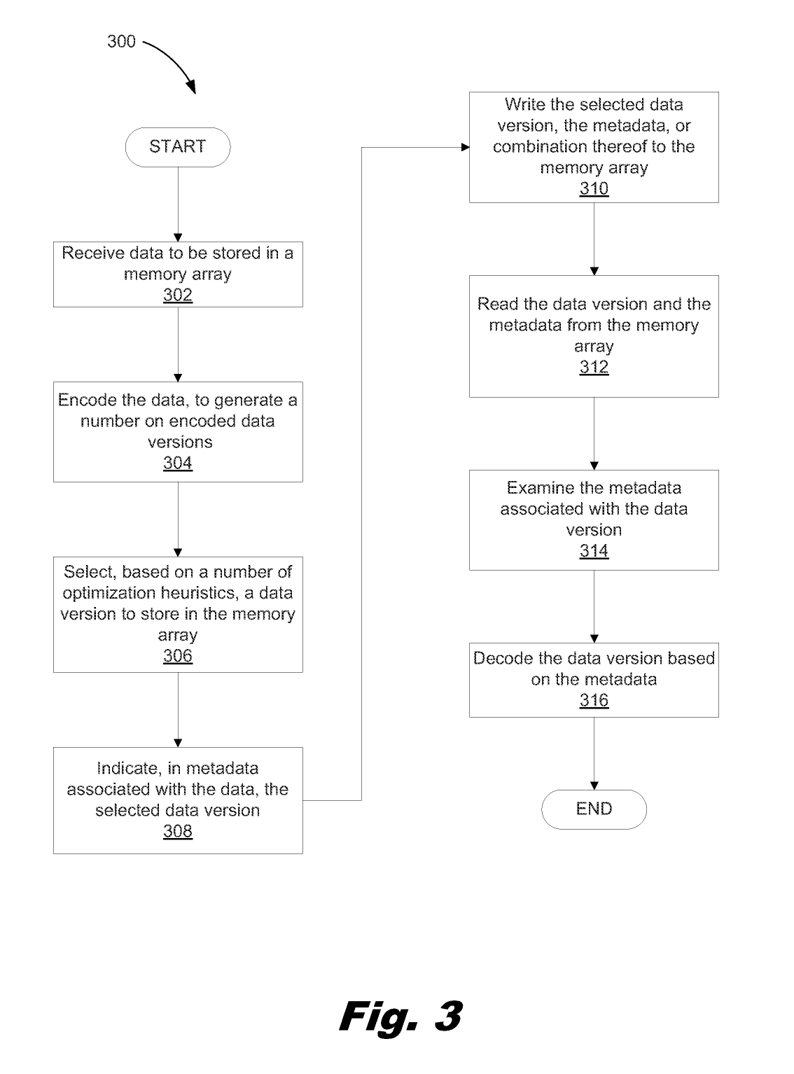

FIG. 3 is a flowchart of a method (300) for encoding data in a memory array (FIG. 1, 118) according to an example of the principles herein. The method (300) may begin by receiving (block 302) data to be stored in a memory array (FIG. 1, 118). In some examples, this may be performed as described in connection with FIG. 2.

The method (300) may include encoding (block 304) the data, to generate a number of encoded data versions. In some examples, this may be performed as described in connection with FIG. 2. The encoded versions may result from performing a bitwise inversion of the data, leaving the data in its original format, or may involve more complex encoding that provides different distributions of output data. The method may produce a number of encoded versions of the original data.

Selecting (block 306) which of the number of data versions to store (block 306) may allow a version of the data to be selected to enhance the behavior of the memory array (FIG. 1, 118) according to the characteristics of the memory array (FIG. 1, 118). In some examples, this may be performed as described in connection with FIG. 2. As described above, a data version may include the number of encoded data versions and the original data. Characteristics of the memory array (FIG. 1, 118) may include factors such as power consumption, memory errors, possible harm to the memory device array to state change, or similar factors.

Once a data version is selected to be stored, the method (300) may include indicating (block 308) in metadata associated with the data, the data version stored. This may be performed as described in connection with FIG. 2. The indication in metadata may vary based on the number of possible encodings available. An example of encodings available may include the original form of the data, or an inversion based on the binary representation of the data. When representations are available, a single binary bit may represent the encoding used. When multiple encodings may be used, a greater number of bits may be used to represent the encoding used on the data.

Writing (block 310) the selected data version, the metadata, or combination thereof may include store the data, the metadata, or combination thereof in a memory array (FIG. 1, 118). Portions or all of the data and metadata may be written based on the need to change the existing memory state. For example, if it is determined that the value to be written is similar to the current state of the memory address, the memory manager (FIG. 1, 104) may determine not to write any values to memory (FIG. 1, 118). In another example, the memory manager (FIG. 1, 104) may determine that the data is different than the current state of memory, but the metadata to be written and the metadata associated with the memory are functionally similar. The memory manager (FIG. 1, 104) may then write the data, but not the metadata, to the memory array (FIG. 1, 118). In a different example, the memory manager (FIG. 1, 104) may determine that a portion of the data is identical to the current state of memory. The memory manager (FIG. 1, 104) may write the portion of the data that is different. In this instance, the memory manager (FIG. 1, 104) may select to write out the metadata and the portion of the data that is different, leaving the remaining portion of the memory unchanged. The memory manager (FIG. 1, 104) may determine for other reasons to write out the data, the metadata, or combination thereof.

The method (300) may include retrieving data from memory (FIG. 1, 118). For example, the method (300) may include reading (block 312) the selected data version and metadata from the memory (FIG. 1, 118). Reading (block 312) the selected data version may consist of invoking system read routines, or may consist of causing the processor (FIG. 1, 102) to write to a memory address. A read may be done on behalf of computer usable code, executed by a processor.

Once the selected data version and metadata is read, the method (300) may include examining (block 314) the metadata associated with the selected data version to determine the encoding used in storing the data. The information to decode the data version may be stored in the metadata.

Based on the metadata indicating the encoding used, the data version may be decoded (block 316) based on the metadata. The decoded data may then be returned to the computer usable code, executed by a processor (FIG. 1, 102), that referenced the data. The data may be referenced as though it had not been encoded, without modification to the referencing code.

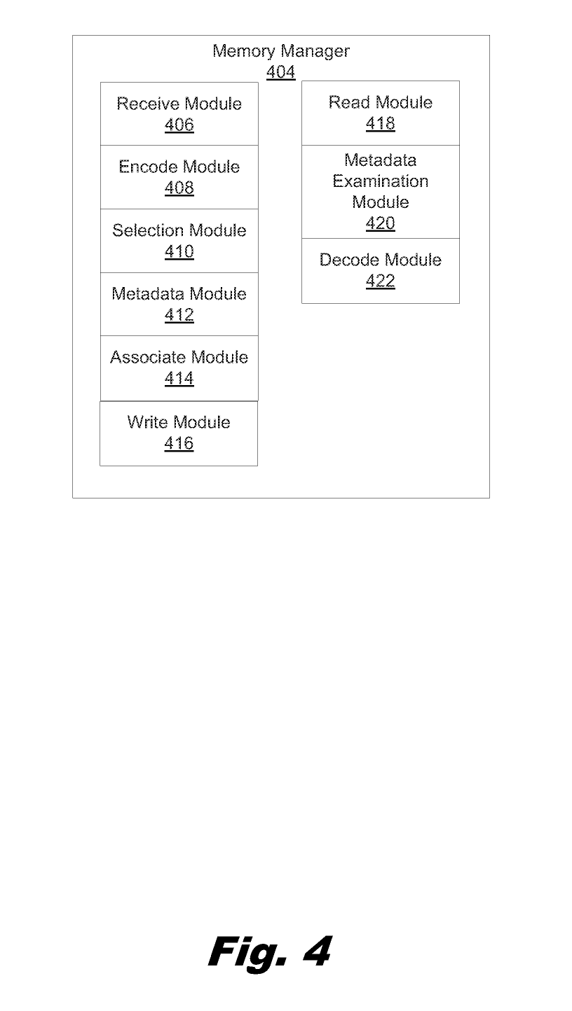

FIG. 4 is an example of a memory manager (404) implemented in accordance with the principles herein. The memory manager (404) may be implemented with a variety of modules to enable receiving data to be written to a memory array (FIG. 1, 118), encoding the data to produce a number of encoded versions, selecting one of the encoded versions or the original data to be written to the memory array (FIG. 1, 118), indicating in metadata the version of data that was selected, associating the metadata with data version to be written, writing the encoded data to the memory array (FIG. 1, 118), reading the encoded version from the memory array (FIG. 1, 118), examining metadata to determine which version of data was selected, and decoding encoded data to restore the data to its original state. Additional modules may be included to expand the functionality of the memory manager (404).

The receive module (406) may receive data to be written to a memory array (FIG. 1, 118). The data may originate from computer usable code, executed by a processor or may originate from some other device. An example of another device would be an input device, such as a keyboard, network card, or camera. The data may be written using interfaces similar to Random Access Memory (RAM), or may be written with system routines associated with files systems.

The encode module (408) may encode the data in accordance with encoding methods. The encoding methods used by the encoding module (408) may include not modifying the data, inverting the binary data, binary shifting the data, or other methods. The encoding may alter the representation and the size of the data.

Based on the encodings performed by the encode module (408) and the original data, the select module (410) may select a data version to write to the memory array (FIG. 1, 118). The data version selected may be based on an optimization heuristic regarding the memory array (FIG. 1, 118), which may include an estimate on power consumption based on the versions of the data, errors in the memory array (FIG. 1, 118) which where the memory manager (FIG. 1, 104) may write a specific value to specific addresses in memory array (FIG. 1, 118), effects changing states when storing the data representation on the memory array (FIG. 1, 118), and other factors.

The metadata module (412) may set metadata associated with the data to indicate which version of the encoded data was selected by the select module (410). The indication may vary in size and structure influenced by the number of encodings the memory manager (404) may use to encode data. The indication in metadata may allow future access to the data to decode the data and determine the original data representation.

The metadata and data version selected may be associated with each other by the associate module (414). The associate module may co-locate the data and metadata. The associate module (414) may inform the system of an alternative method to determine a relationship between the data and metadata.

The write module (416) may write the data version selected, the metadata, or combination thereof to a memory array. Portions or all of the selected data version, metadata, or combination thereof may be written based on the need to change the existing memory state. The write module may efficiently store the data by writing the data, the metadata, or combination thereof.

A read module (418) may retrieve the data, metadata, or combination thereof from the memory array. The read module may accomplish retrieving the data in a single instruction, or in multiple instructions.

A metadata examination module (420) may examine the metadata, as may be retrieved by the read module (418) to determine the state of the data. The state may include the encoding used to encode the data prior to storage.

Based on the examination of the metadata examination module, the decode module (422) may decode the data version selected and restore the data version to an original state. The decoding, based on the encoding used, may allow other code and subsystems to reference the data as though the data had never been encoded.

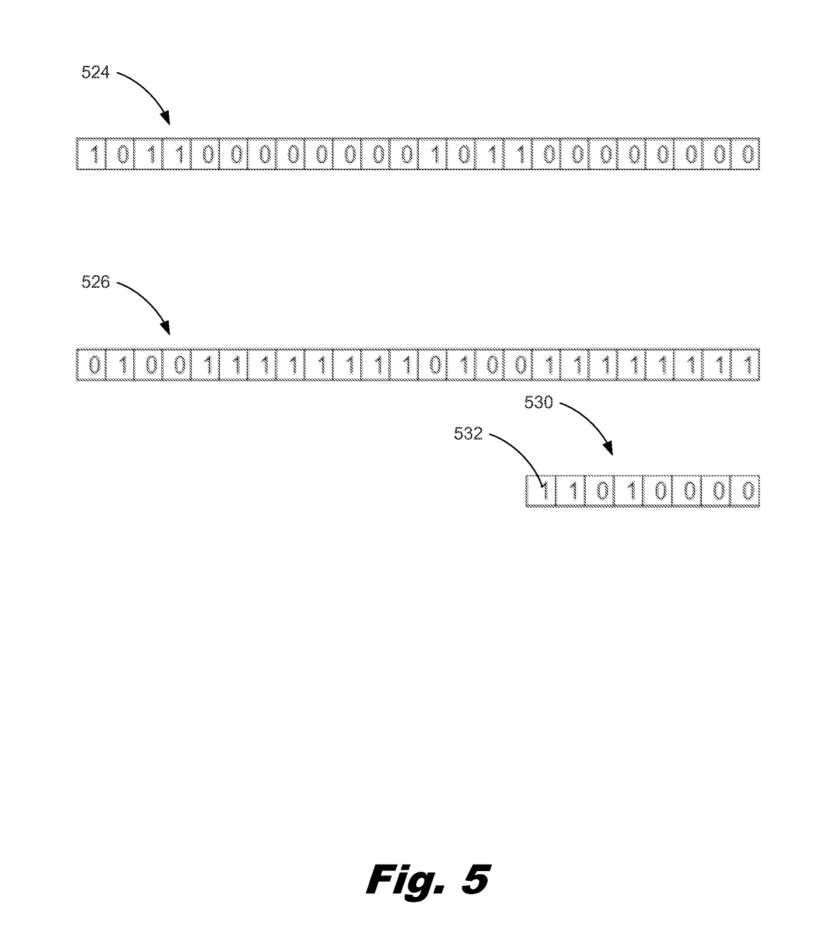

FIG. 5 represents data (524) as may be processed by an example of the principles described herein. While specific reference has been made to a particular encoding, any number of encodings may be used to generate the encoded data versions. While one version of encoded data is presented, any number of encoded versions may be generated. Accordingly, any number of encoded data versions or the original data may be selected by the selection module. The original data (524) is shown in a binary format consisting of 6 values being 1, and 26 values being zero. The data is shown as it may be received by a receive module (FIG. 4, 406)

An encode module (FIG. 4, 408) may alter the representation of the data (524). For example, encoded data (526) may represent an inverted version of the original data (524). In other words, every one bit has been replaced by zero bit, and every zero bit has been replaced by a one. The encoded data (526) may include 26 one values, and 6 zero values. The select module (FIG. 4, 410) may select to write, based on the characteristics of a memory array, a data set that contains a greater number of on or one bits, due to the projected power consumption of the device. In comparing the original data (524) with the encoded data (526) the select module (FIG. 4, 410) may determine that the encoded data (526) is more efficient to store than the original data (524) because it contains more 1 bits than the original data (524).

The metadata module (FIG. 4, 412) may then set the metadata (530) to represent that the encoded data (526) is stored. The metadata (530) may be represented by 8 bits. One encoding representation bit (532) may represent that the data has been encoded, and is set to one as an indication. In a system where two encodings of the data are allowed, one bit may represent which encoding is used. If more than two encodings are allowed, then a number of additional bits may represent the encoding. Remaining metadata bits representing ECC may be calculated to protect the encoded data and the encoding metadata. In some examples, the memory manager (FIG. 1, 102) may consider ECC and other metadata bits when selecting the data version to store to the memory array (FIG. 1, 118). Similarly, the memory manager (FIG. 1, 102) may consider other, unrelated metadata bits when encoding to optimize memory states.

When the data is read from the memory device, the memory manager (FIG. 4, 404) may read the metadata and determine that the data is encoded. The memory manager (FIG. 4. 404) may then read and decode the encoded data (526) and restore the encoded data (526) to appear as the original data (524) prior to the use of the original data (524) by a processor or other modules.

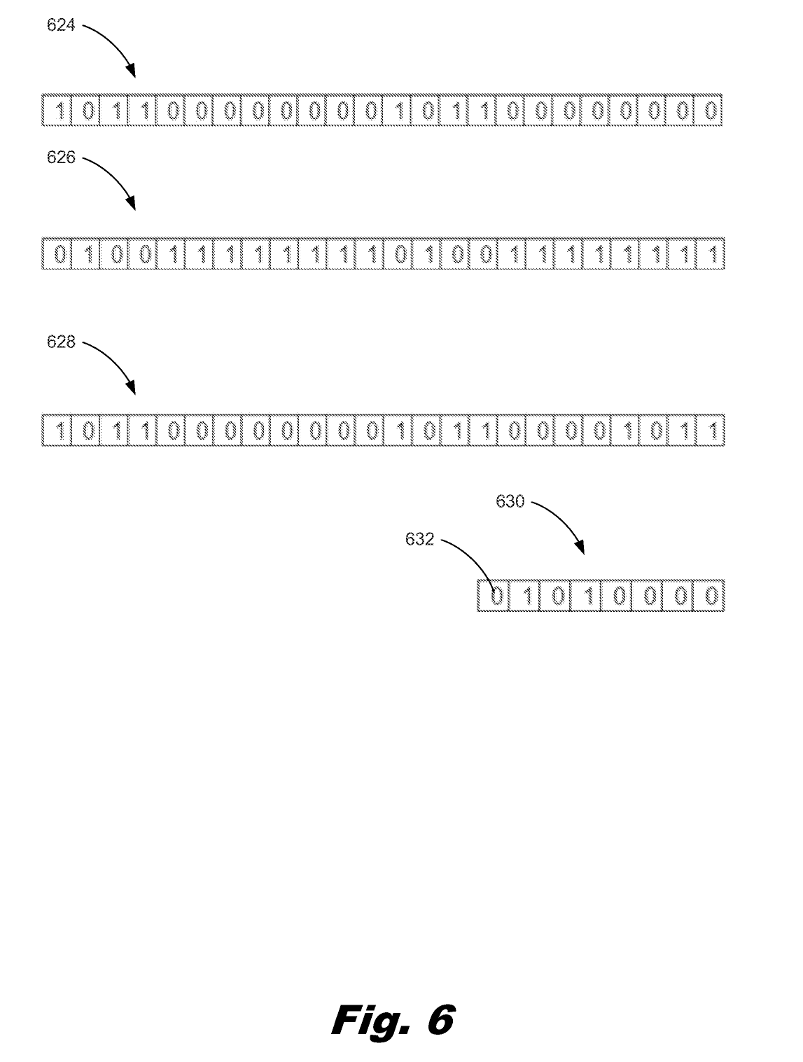

FIG. 6 represents data as may be processed by an example of the principles described herein. The original data (624) is shown in a binary format consisting of 6 values being 1, and 26 values being zero. The data (624) is shown as it may be received by a receive module (FIG. 4, 406)

An encoding module (FIG. 4, 408) may generate an encoded version of the data. As depicted in FIG. 6, the encoded data (626) may be an inversion of the original data (624), such that every one bit has been replaced by a zero bit, and every zero bit has been replaced by a one bit. The encoded data (626) has 26 one values, and six zero values.

The select module (FIG. 1, 110) may compare the original data (624) and the encoded data (626) with the current memory state (628) to minimize the number of bits that will change state in the write. The original data (624) and the current memory state (628) have 29 digits in common. A write of the original data would result in 3 digits changing state from one to zero. By contrast, the encoded data (626) has three digits in common with the current memory state (628). A write of the encoded data (626) would result in three digits remaining unchanged and 29 digits changing state. In order to reduce the number of digits changing state, and reduce the possibility that a memory array (FIG. 1, 118) that allows a finite number of state changes may exceed that limit, the select module (FIG. 1, 110) may select the original data (624) to be written to the memory array (FIG. 1, 118).

The metadata module (FIG. 4, 412) may then indicate in metadata (630), that the stored data is using the original data (624), by setting the encoding representation bit (632) to off or zero for example.

A read module (FIG. 4, 418) may read metadata and data read that contain data in the pattern of the metadata (630) and the original data (624). The metadata examination module (FIG. 2, 420) may examine the metadata (630) and determine that the data is currently decoded, and may return the data to the caller.

The data shown in FIG. 5 and FIG. 6 is shown in 32 bit format. The data may also be encoded on a cache granularity, or other granularity, according the architecture of the computing product.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (102) of the memory system (100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for encoding data in a memory array, comprising:
receiving data to be stored in the memory array;
encoding the data, to generate a number of encoded data versions;
selecting, based on a number of optimization heuristics, which of a number of data versions to store in the memory array, in which the number of data versions comprise the number of encoded data versions and the data;
indicating, in metadata associated with the data, the selected data version; and
writing the selected data version, the metadata, or combination thereof, to the memory array.

2. The method of claim 1, further comprising:
reading the selected data version, the metadata, or combination thereof, from the memory array;
examining the metadata associated with the selected data version; and
decoding the selected data version based on the metadata.

3. The method of claim 1, in which selecting which of the number of data versions to store in the memory array is based on reducing the power consumption of the memory array due to a value of data stored in the memory array.

4. The method of claim 1, in which an encoding data version is a bitwise inversion of the data.

5. The method of claim 1, in which an encoded data version is based on information from data patterns which have previously been written.

6. The method of claim 1, in which the metadata is stored as part of an error checking and correction system.

7. The method of claim 1, in which the optimization heuristic is based on a memory array architecture.

8. The method of claim 1, in which encoding the data comprises:
reading information relating to bit errors in the memory array; and
adjusting the profile of the data to ensure any bit with an error remains in a consistent state.

9. The method of claim 8, further comprising writing an embedded pointer indicating a remapped location for the data.

10. A system for encoding data in a memory array, comprising:
a processor;
memory communicatively coupled to the processor; and
a memory manager, the memory manager comprising:
a receiver to receive data to be written to the memory array
an encode module to encode the data to generate a number of encoded data versions;
a select module to compare the encoded data versions and the data, and select one of the encoded data versions and the data based on a number of optimization heuristics;
a metadata module to generate a number of metadata bits, in which the metadata bits indicate the version selected;
an association module to associate the number of metadata bits with the selected data; and
a write module to write the selected data, metadata, or combination thereof, to the memory array.

11. The system of claim 10, in which the memory associated with the processor is a memristor array.

12. The system of claim 10, in which the memory associated with the processor is a cross bar memory array.

13. The system in claim 10, in which the data is encoded at a cache line granularity.

14. A computer program product for encoding data in a memory array, the computer program product comprising:
a computer readable storage medium comprising computer usable program code embodied therewith, the computer usable program code comprising:
computer usable program code to, when executed by a processor, receive data to be stored in a memory array;
computer usable program code to, when executed by a processor, encode the data to generate a number of encoded data versions;
computer usable program code to, when executed by a processor, select one of the data and an encoded data versions to store in the memory array.
computer usable program code to, when executed by a processor, indicate, via metadata associated with the data, the selected data; and
computer usable program code to, when executed by a processor, write the selected data and the metadata to the memory array.

15. The product of claim 14, further comprising:
computer usable program code to, when executed by a processor, read the selected data, the metadata, or combination thereof from the memory array; and
computer usable program code to, when executed by a processor, decode the selected data based on the metadata.
